(19) United States
(12) Patent Application Publication
(10) Pub. No.: US 2026/0079281 A1
(43) Pub. Date: Mar. 19, 2026

(54) METHOD FOR CALCULATING DYNAMIC ICE PRESSURE ON EARTH-ROCKFILL DAM UNDER ACTION OF WAVE AND WIND LOADS

(71) Applicant: NANJING HYDRAULIC RESEARCH INSTITUTE, Jiangsu (CN)

(72) Inventors: Liuyan Liu, Jiangsu (CN); Zhuo Li, Jiangsu (CN); Xinyi Liu, Jiangsu (CN); Yi Sun, Jiangsu (CN); Qinxia Zhu, Jiangsu (CN); Chaoda Bi, Jiangsu (CN); Jingdong Jiang, Jiangsu (CN); Guangya Fan, Jiangsu (CN)

(73) Assignee: NANJING HYDRAULIC RESEARCH INSTITUTE, Jiangsu (CN)

(21) Appl. No.: 18/922,447

(22) Filed: Oct. 22, 2024

(30) Foreign Application Priority Data
Sep. 19, 2024 (CN) 202411307398.3

(51) Int. Cl. G01V 20/00

(52) U.S. Cl. CPC G01V 20/00

(57) ABSTRACT

Disclosed is a method for calculating dynamic ice pressure on an earth-rockfill dam under the action of wave and wind loads, including obtaining calculation parameters of an ice layer under a multi-year average winter temperature; arranging a wave measurement device in a water area in front of the earth-rockfill dam to collect winter wave parameters; calculating an extreme wave height that causes ice cracking according to the calculation parameters and the winter wave parameters; determining whether the ice layer generates a crack due to wave fluctuations; calculating a critical ice thickness that causes flexural failure of the ice layer with or without the crack, and comparing the critical ice thickness with an actual ice thickness measured over the water area to determine a type of ice layer, and calculating the dynamic ice pressure exerted by the ice layer on the earth-rockfill due to the action wave and wind loads.

### CROSS-REFERENCE TO RELATED APPLICATIONS

This application claims the benefit of priority from Chinese Patent Application No. 202411307398.3, filed on Sep. 19, 2024. The content of the aforementioned application, including any intervening amendments thereto, is incorporated herein by reference in its entirety.

### TECHNICAL FIELD

The present disclosure relates to methods for calculating dynamic ice pressure on earth-rockfill dams, and particularly relates to a method for calculating dynamic ice pressure on an earth-rockfill dam under the action of wave and wind loads.

### BACKGROUND

Under the action of wave and wind loads, large areas of ice layer move as a whole, generating dynamic ice pressure on an earth-rockfill dam slope protection that hinders relative movements of the ice layer, this process is usually accompanied by cracks of ice layer and formation of rafted ice. In the design of a hydraulic structure, it is necessary to calculate the dynamic ice pressure to determine strength of the hydraulic structure, in order to ensure the safety of an earth-rockfill dam slope protection structure and to prevent the dynamic ice pressure from damaging the structure. Currently, the dynamic ice pressure is usually calculated according to a calculation formula stated in the Specification for Load Design of Hydraulic Structures (SL744-2016), which has the following problems: (1) single-layer ice and rafted ice are not distinguished during the calculation, resulting in low calculation accuracy; and (2) the applicability is poor, and objects of action are limited to vertical dam surfaces or other wide and elongated structures.

### SUMMARY

An objective of the present disclosure is to provide a method for calculating dynamic ice pressure on an earth-rockfill dam under the action of wave and wind loads with strong applicability and high calculation accuracy.

Technical solution: the method for calculating dynamic ice pressure on an earth-rockfill dam under the action of wave and wind loads provided in the present disclosure includes: determining a type of ice layer, the type of ice layer includes single-layer ice and rafted ice;
when the ice layer is the single-layer ice, a formula for calculating dynamic ice pressure F is as follows:

$$F = m λ ( 0 \text{.18} {b}^{0.5} {h}^{1.2} {σ}_{c} + γδ {vA}_{1} sin {θ}_{1} + 0.0 \; 15 β {wA}_{2} sin {θ}_{2} )$$

where m is a dam slope shape coefficient; λ is a dam slope gradient coefficient; b is a width of the ice layer, denoted in m; h is a thickness of the ice layer, denoted in m; σ_{c} is uniaxial compressive strength of the ice layer, denoted in kPa; γ is a coefficient related to roughness of an undersurface of the ice layer, taken as 1 kN·s/m³ for the single-layer ice; δ is a viscosity coefficient of the ice layer; v is a water flow velocity beneath the ice layer, denoted in m/s; A₁ is an undersurface area of the ice layer, denoted in m²; θ₁ is a horizontal angle between a water flow direction and a dam slope, denoted in °; β is a contact coefficient, taken as 0.4-0.7; w is a standard wind pressure over a water area, denoted in kN/m²; A₂ is an upper surface area of the ice layer, denoted in m²; and θ₂ is a horizontal angle between a wind direction and the dam slope, denoted in °;
when the ice layer is the rafted ice, a formula for calculating dynamic ice pressure F is as follows:

$$F = m λ ( 0.2 {b}^{0.5} {h}^{1.1} {σ}_{c} + γδ {vA}_{1} sin {θ}_{1} + 0.0 \; 15 β {wA}_{2} sin {θ}_{2} )$$

where γ is a coefficient related to roughness of an undersurface of the ice layer, taken as 1.2 kN·s/m³ for the rafted ice.

Further, a method for determining a type of ice layer includes:
obtaining calculation parameters of the ice layer under a multi-year average winter temperature in a local area through experiments, including density ρ, uniaxial compressive strength σ_{c}, flexural strength σ_{f}, elastic modulus E, and Poisson's ratio ν of the ice; and arranging a wave measurement device in a water area in front of the earth-rockfill dam to collect winter wave parameters of the water area, including wave height H, wave period T and wave speed c;
calculating an extreme wave height that causes ice cracking according to the calculation parameters of the ice layer and the winter wave parameters of the water area; introducing an elastic-thin-plate bending theory, and the extreme wave height is a wave height corresponding to internal stress of the ice layer when the internal stress is flexural strength of the ice layer; and determining whether the ice layer generates a crack due to wave fluctuations by comparing the extreme wave height for ice cracking with a maximum wave height measured over the water area; and
calculating a critical ice thickness that causes flexural failure of the ice layer with or without the crack, and comparing the critical ice thickness with an actual ice thickness measured in front of the dam to determine the type of ice layer.

Further, when the maximum wave height measured over the water area is equal to and less than the extreme wave height, the ice layer will not generate the crack; and when the maximum wave height measured over the water area is greater than the extreme wave height, the ice layer will generate the crack.

Further, when the actual ice thickness is less than and equal to the critical ice thickness, the type of ice layer is single-layer ice; and when the actual ice thickness is greater than the critical ice thickness, the type of ice layer is rafted ice.

Further, a formula for calculating the extreme wave height Hₘₐₓ for ice cracking is as follows:

$${H}_{max} = \frac{{σ}_{f} ( 1 - {v}^{2} )}{0.25 Eh} {( \frac{L}{cT} )}^{- 3}$$

where, L is a length of the ice layer, denoted in m.

Further, a formula for calculating the critical ice thickness h₁ₘₐₓ that causes flexural failure of the ice layer with the crack is as follows:

$${h}_{1 max} = \frac{{σ}_{c}^{2} ( 1 - {ν}^{2} )}{ερ gE}$$

where, ε is a coefficient related to salinity and porosity of the ice layer, taken as 0.4-0.6; and g is gravitational acceleration, taken as 9.8 m/s².

Further, a formula for calculating the critical ice thickness h₂ₘₐₓ that causes flexural failure of the ice layer without the crack is as follows:

$${h}_{2 max} = \frac{{σ}_{c}^{2} ( 1 - {ν}^{2} )}{9 ερ gE}$$

where, ε is a coefficient related to salinity and porosity of the ice layer, taken as 0.4-0.6; and g is gravitational acceleration, taken as 9.8 m/s².

Further, the dam slope shape coefficient is indicated with m, which is taken as 1 for a rectangular, and 0.9 for a polygon or a circle.

Further, the dam slope gradient coefficient is indicated with λ, which is taken as 1 for a dam slope inclination of 0°-15°, and 0.8 for a dam slope inclination angle of 15°-45°.

Further, the viscosity coefficient of the ice layer is indicated with δ, which is taken as 1 for a temperature under −10° C., 0.95 for a temperature of −10° C.-0° C., and 0.9 for a temperature above 0° C.

Beneficial effects: compared with the prior art, the present invention has the following advantages:
(1) The type of ice layer is refined, and different formulae are adopted to calculate the dynamic ice pressure of single-layer ice and rafted ice, improving the calculation accuracy of dynamic ice pressure of the earth-rockfill dam slope protection.
(2) The calculation formulae of the dynamic ice pressure takes into account dam slope parameters, such as the dam shape coefficient and dam slope gradient coefficient, making them more conformable to actual conditions of the earth-rockfill dam, therefore, the formulae can be used to calculate the dynamic ice pressure for earth-rockfill dams with different slope ratios and shapes, addressing the limitations of objects of the dynamic ice pressure stated in the Specification for Load Design of Hydraulic Structures (SL744-2016). The method has greater applicability.
(3) The method analyzes and optimizes the calculation formula of the dynamic ice pressure stated in the Specification for Load Design of Hydraulic Structures (SL744-2016), resolving the problem of inconsistent units in the formula.

### BRIEF DESCRIPTION OF THE DRAWINGS

FIG. 1 is a flow block diagram of a method for calculating dynamic ice pressure on an earth-rockfill dam under the action of wave and wind loads according to an embodiment of the present disclosure.

FIG. 2 is a schematic diagram showing deformation of an ice layer caused by wave fluctuations according to an embodiment of the present disclosure.

FIG. 3 is a schematic diagram of dynamic ice pressure exerted on an earth-rockfill dam slop by different types of ice layer according to an embodiment of the present disclosure.

### DETAILED DESCRIPTIONS OF THE EMBODIMENTS

The present disclosure will be further described below with reference to the accompanying drawings.

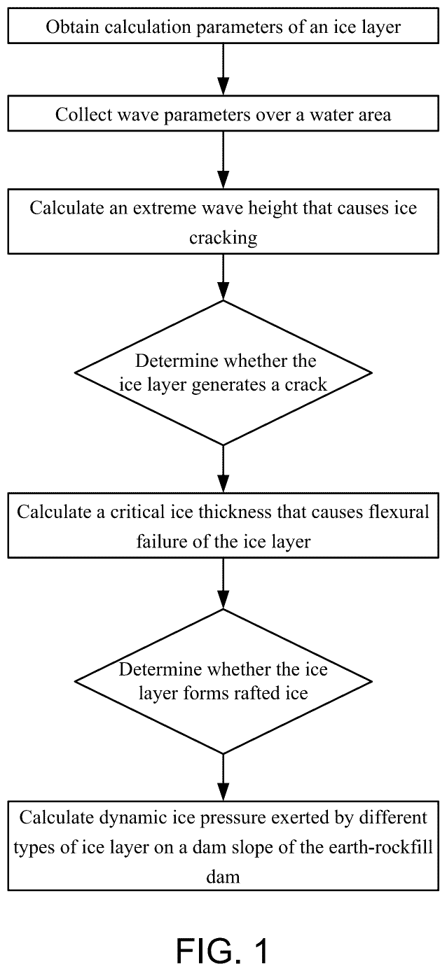

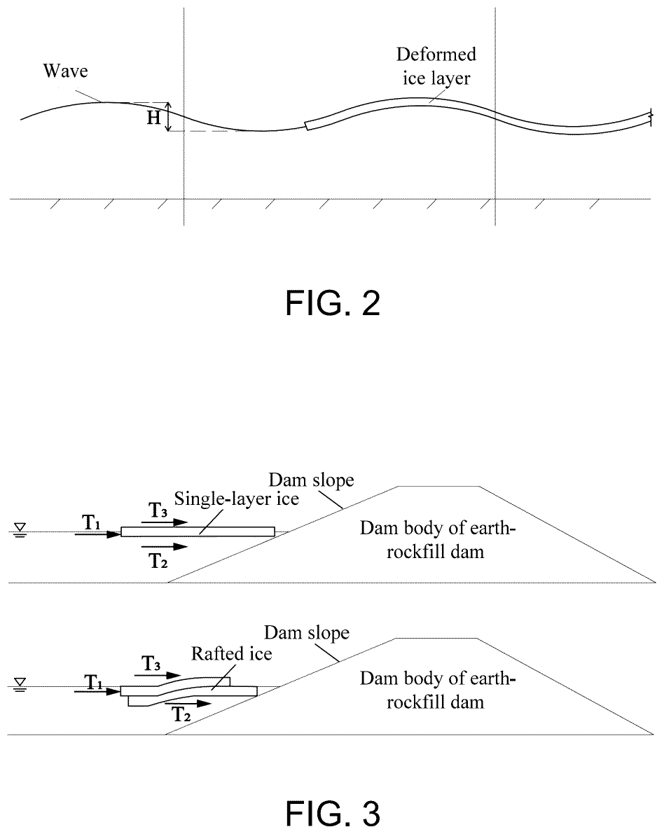

As shown in FIG. 1, an embodiment of the present disclosure provides a method for calculating dynamic ice pressure on an earth-rockfill dam under the action of wave and wind loads, specifically including the following steps:
(1) obtain calculation parameters of the ice layer under a multi-year average winter temperature in a local area through experiments, including density ρ, uniaxial compressive strength σ_{c}, flexural strength σ_{f}, elastic modulus E, and Poisson's ratio ν of the ice; and arrange a wave measurement device in a water area in front of the earth-rockfill dam to collect winter wave parameters of a water area, including wave height H, wave period T and wave speed c.
(2) Calculate an extreme wave height that causes ice cracking according to the calculation parameters of the ice layer and the winter wave parameters of the water area. As shown in FIG. 2, when a wave in the water area propagates from upstream to a direction of the earth-rockfill dam, wave energy generated therefrom enters an ice layer from an edge of the ice layer, resulting in bending and deformation of the ice layer. Therefore, an elastic-thin-plate bending theory is introduced to calculate bending stress caused by deformation of waves at different wave heights. When internal stress of the ice layer equals to the flexural strength of ice, the corresponding wave height is the extreme wave height that causes ice cracking.

A formula for calculating the extreme wave height Hₘₐₓ for ice cracking is as follows:

$${H}_{max} = \frac{{σ}_{f} ( 1 - {ν}^{2} )}{0.25 E h} {( \frac{L}{c T} )}^{- 3} \qquad ( 1 )$$

where, Hₘₐₓ is an extreme wave height that causes ice to generate a crack, denoted in m; σ_{f} is flexural strength of the ice, denoted in kPa; ν is a Poisson's ratio of the ice; E is elastic modulus of the ice, denoted in kPa; h is a thickness of the ice layer, denoted in m; L is a length of the ice layer, denoted in m; c is a wave speed, denoted in m/s; and T is a wave period, denoted in s.

Further, by comparing the extreme wave height for ice cracking with a maximum wave height measured over the water area, it is determined whether the ice layer generates the crack due to wave fluctuations. Specifically, when the maximum wave height measured over the water area is equal to and less than the extreme wave height, the ice layer will not generate the crack; and when the maximum wave height measured over the water area is greater than the extreme wave height, the ice layer will generate the crack.
(3) Calculate a critical ice thickness that causes flexural failure of the ice layer with or without the crack on the basis determining whether the ice layer has the crack in the step (2), and compare the critical ice thickness with an actual ice thickness measured in front of the dam to determine a type of ice layer, as the internal stress accumulated changes in a motion state of the ice layer could cause flexural failure of the ice layer, resulting in rafted ice. Specifically, when the actual ice thickness is less than and equal to the critical ice thickness, the type of ice layer is single-layer ice; and when the actual ice thickness is greater than the critical ice thickness, the type of ice layer is rafted ice.

A formula for calculating the critical ice thickness h₁ₘₐₓ that causes flexural failure of the ice layer with the crack is as follows:

$${h}_{1 max} = \frac{{σ}_{c}^{2} ( 1 - {ν}^{2} )}{ερ gE} \qquad ( 2 )$$

where h₁ₘₐₓ is a critical ice thickness that causes flexural failure of the ice layer with the crack, denoted in m; σ_{c} is uniaxial compressive strength of the ice layer, denoted in kPa; ν is a Poisson's ratio of the ice; ε is a coefficient related to salinity and porosity of the ice layer, generally taken as 0.4-0.6; ρ is a density of the ice, denoted in kg/m³; g is gravitational acceleration, taken as 9.8 m/s²; and E is an elastic modulus of the ice, denoted in kPa.

A formula for calculating the critical ice thickness h₂ₘₐₓ that causes flexural failure of the ice layer without the crack is as follows:

$${h}_{2 max} = \frac{{σ}_{c}^{2} ( 1 - {ν}^{2} )}{9 ερ gE} \qquad ( 3 )$$

where h₂ₘₐₓ is a critical ice thickness that causes flexural failure of the ice layer without the crack, denoted in m.
(4) Calculate dynamic ice pressure exerted by the ice layer on a dam slope of the earth-rockfill dam due to the action wave and wind loads.

As shown in FIG. 3, the dynamic ice pressure includes compressive force T₁ of the wave on a cross section of the ice layer, frictional force T₂ of the wave on an undersurface of the ice layer, and frictional force T₃ of wind load on an upper surface of the ice layer.

The type of ice layer is identified as the single-layer ice or the rafted ice according to the steps (1) to (3); and
when the ice layer is the single-layer ice, a formula for calculating dynamic ice pressure F is as follows:

$$F = m λ ( 0.18 {b}^{0.5} {h}^{1.2} {σ}_{c} + γδ {vA}_{1} sin {θ}_{1} + 0.0 \; 15 β {wA}_{2} sin {θ}_{2} ) \qquad ( 4 )$$

where m is a dam slope shape coefficient, which is taken as 1 for a rectangular, 0.9 for a polygon or a circle; λ is a dam slope gradient coefficient, which is taken as 1 for a dam slope inclination of 0°-15°, and 0.8 for a dam slope inclination angle of 15°-45°; b is a width of the ice layer, denoted in m; h is a thickness of the ice layer, denoted in m; σ_{c} is uniaxial compressive strength of the ice layer, denoted in kPa; γ is a coefficient related to roughness of an undersurface of the ice layer, taken as 1 kN·s/m³ for the single-layer ice; δ is a viscosity coefficient of the ice layer, which is taken as 1 for a temperature under −10° C., 0.95 for a temperature of −10° C.-0° C., and 0.9 for a temperature above 0° C.; v is a water flow velocity beneath the ice layer, denoted in m/s; A₁ is an undersurface area of the ice layer, denoted in m²; θ₁ is a horizontal angle between a water flow direction and a dam slope, denoted in °; β is a contact coefficient, which is taken as 0.4-0.7; w is a standard wind pressure over the water area, denoted in kN/m²; A₂ is an upper surface area of the ice layer, denoted in m²; and θ₂ is a horizontal angle between a wind direction and the dam slope, denoted in °;
when the ice layer is the rafted ice, a formula for calculating dynamic ice pressure F is as follows:

$$F = m λ ( 0.2 {b}^{0.5} {h}^{1.1} {σ}_{c} + γδ {vA}_{1} sin {θ}_{1} + 0.0 \; 15 β {wA}_{2} sin {θ}_{2} ) \qquad ( 5 )$$

where γ is a coefficient related to roughness of an undersurface of the ice layer, taken as 1.2 kN·s/m³ for the rafted ice.

In one specific embodiment, dynamic ice pressure exerted by the ice layer on a dam slope of the earth-rockfill dam due to the action wave and wind loads on a day is calculated. Specifically, a test temperature is controlled to be the multi-year average winter temperature in the local area. According to measurement, a density of the ice is 0.998×10³ kg/m³, uniaxial compressive strength is 2×10³ kPa, flexural strength is 1×10³ kPa, elastic modulus is 3×10⁶ kPa, and a Poisson's ratio is 0.35. The collected parameters of wave in front of the dam show that an average wave speed is 5 m/s, an average period is 6 s, and a maximum wave height is 1 m in the water area in winter. Thickness, length and width of the ice layer measured in front of the dam are 0.6 m, 6 m and 10 m, respectively; upper surface area and undersurface area of the ice layer re 92 m² and 75 m², respectively. A water flow velocity beneath the ice layer is 3 m/s, and a horizontal angle between a water flow direction and a dam slope is 85°. A standard wind pressure over the water area is 1.52 kN/m², and a horizontal angle between an average wind direction and the dam slope on the day is 60°. An upstream damp slope gradient of the dam in a reservoir is 1:2.5, a dam slope gradient coefficient is taken as 0.8, a contact surface is a rectangular, and a dam slope shape coefficient is taken as 1. A temperature on the day is −5° C., and a viscosity coefficient of the ice layer is 0.95. An upper surface of the ice layer is relatively rough, and a contact coefficient is taken as 0.6. ε is taken as 0.4.

First, an extreme wave height that causes ice cracking is calculated according to Formula (1).

$${H}_{max} = \frac{1 \times {10}^{3} \times ( 1 - 0.3 {5}^{2} )}{0.25 \times 3 \times 1 {0}^{6} \times 0.6} \times {( \frac{6}{5 \times 6} )}^{- 3} = 0.2 \; 44 m$$

The calculated calculate extreme wave height is 0.244 m, Therefore, the maximum wave height in the water area exceeds the extreme wave height, and the ice layer generates a crack.

A critical ice thickness that causes flexural failure of the ice layer is calculated according to Formula (2).

$${h}_{1 max} = \frac{4 \times 1 {0}^{12} \times ( 1 - 0.3 {5}^{2} )}{0.4 \times 0.998 \times 1 {0}^{3} \times 9.8 \times 3 \times 1 {0}^{9}} = 0.2 \; 99 m$$

The calculated critical ice thickness is 0.299 m, in which case, the ice thickness in front of the dam is greater than the critical ice thickness, indicating that a type of the ice layer is rafted ice, therefore, the dynamic ice pressure exerted by the ice layer on a dam slope of the earth-rockfill dam is calculated according to Formula (5).

$$F = 1 \times 0.8 \times ( 0.2 \times 1 {0}^{0.5} \times 0 . {6}^{1.1} \times 2000 + 1.2 \times 0.95 \times 3 \times 75 \times 0.9 \; 96 + 0.015 \times 0.6 \times 92 \times \frac{\sqrt{3}}{2} ) = 78 \; 1.8 \; 74 kN$$

The calculated dynamic ice pressure is 781.874 kN. The dynamic ice pressure calculated according to a calculation formula stated in the Specification for Load Design of Hydraulic Structures (SL744-2016) is 636.644 kN.

In another specific embodiment, thickness, length and width of the ice layer measured in front of the dam on a day are 0.25 m, 5.5 m and 8 m, respectively; upper surface area and undersurface area of the ice layer re 50 m² and 45 m², respectively. Other parameters are the same as those in the previous example. According to calculation, an extreme wave height that causes ice cracking is 0.76 m. Therefore, the maximum wave height in the water area exceeds the extreme wave height, the ice layer generates a crack. A critical ice thickness that causes flexural failure of the ice layer is 0.299 m according to Formula (2), in which case, the ice thickness in front of the dam is less than the critical ice thickness, indicating that a type of the ice layer is single-layer ice, therefore, the dynamic ice pressure exerted by flow of the ice layer on a cold-region reservoir dam is calculated according to Formula (4).

The calculated dynamic ice pressure is 279.948 kN. The dynamic ice pressure calculated according to a calculation formula stated in the Specification for Load Design of Hydraulic Structures (SL744-2016) is 203.332 kN.

What is claimed is:

1. A method for calculating dynamic ice pressure on an earth-rockfill dam under the action of wave and wind loads, comprising: determining a type of ice layer, the type of ice layer comprises single-layer ice and rafted ice;
when the ice layer is the single-layer ice, a formula for calculating dynamic ice pressure F is as follows:
$$F = m λ ( 0.18 {b}^{0.5} {h}^{1.2} {σ}_{c} + γδ {vA}_{1} sin {θ}_{1} + 0.0 \; 15 β {wA}_{2} sin {θ}_{2} )$$
in the formula, m is a dam slope shape coefficient; λ is a dam slope gradient coefficient; b is a width of the ice layer, denoted in m; h is a thickness of the ice layer, denoted in m; σ_{c} is uniaxial compressive strength of the ice layer, denoted in kPa; γ is a coefficient related to roughness of an undersurface of the ice layer, taken as 1 kN·s/m³ for the single-layer ice; δ is a viscosity coefficient of the ice layer; v is a water flow velocity beneath the ice layer, denoted in m/s; A₁ is an undersurface area of the ice layer, denoted in m²; θ₁ is a horizontal angle between a water flow direction and a dam slope, denoted in °; β is a contact coefficient, taken as 0.4-0.7; w is a standard wind pressure over a water area, denoted in kN/m²; A₂ is an upper surface area of the ice layer, denoted in m²; and θ₂ is a horizontal angle between a wind direction and the dam slope, denoted in °;
when the ice layer is the rafted ice, a formula for calculating dynamic ice pressure F is as follows:
$$F = m λ ( 0.2 {b}^{0.5} {h}^{1.1} {σ}_{c} + γδ {vA}_{1} sin {θ}_{1} + 0.0 \; 15 β {wA}_{2} sin {θ}_{2} )$$
wherein γ is a coefficient related to roughness of an undersurface of the ice layer, taken as 1.2 kN·s/m³ for the rafted ice.

2. The method for calculating the dynamic ice pressure on the earth-rockfill dam under the action of the wave and wind loads according to claim 1, wherein a method for determining a type of ice layer comprises:
obtaining calculation parameters of the ice layer under a multi-year average winter temperature in a local area through experiments, wherein the parameters comprise density ρ, uniaxial compressive strength σ_{c}, flexural strength σ_{f}, elastic modulus E, and Poisson's ratio ν of the ice layer; and arranging a wave measurement device in a water area in front of the earth-rockfill dam to collect winter wave parameters of the water area, comprising wave height H, wave period T and wave speed c;
calculating an extreme wave height that causes ice cracking according to the calculation parameters of the ice layer and the winter wave parameters of the water area; introducing an elastic-thin-plate bending theory, and the extreme wave height is a wave height corresponding to internal stress of the ice layer when the internal stress is flexural strength of the ice layer; and determining whether the ice layer generates a crack due to wave fluctuations by comparing the extreme wave height for ice cracking with a maximum wave height measured over the water area; and
calculating a critical ice thickness that causes flexural failure of the ice layer with or without the crack, and comparing the critical ice thickness with an actual ice thickness measured in front of the dam to determine the type of ice layer.

3. The method for calculating the dynamic ice pressure on the earth-rockfill dam under the action of the wave and wind loads according to claim 2, wherein when the maximum wave height measured over the water area is equal to and less than the extreme wave height, the ice layer will not generate the crack; and when the maximum wave height measured over the water area is greater than the extreme wave height, the ice layer will generate the crack.

4. The method for calculating the dynamic ice pressure on the earth-rockfill dam under the action of the wave and wind loads according to claim 2, wherein when the actual ice thickness is less than and equal to the critical ice thickness, the type of ice layer is single-layer ice; and when the actual ice thickness is greater than the critical ice thickness, the type of ice layer is rafted ice.

5. The method for calculating the dynamic ice pressure on the earth-rockfill dam under the action of the wave and wind loads according to claim 2, wherein a formula for calculating the extreme wave height Hₘₐₓ for ice cracking is as follows:
$${H}_{max} = \frac{{σ}_{f} ( 1 - {ν}^{2} )}{0.25 E h} {( \frac{L}{c T} )}^{- 3}$$
in the formula, L is a length of the ice layer, denoted in m.

6. The method for calculating the dynamic ice pressure on the earth-rockfill dam under the action of the wave and wind loads according to claim 2, wherein a formula for calculating the critical ice thickness h₁ₘₐₓ that causes flexural failure of the ice layer with the crack is as follows:
$${h}_{1 max} = \frac{{σ}_{c}^{2} ( 1 - {ν}^{2} )}{ερ gE}$$
in the formula, ε is a coefficient related to salinity and porosity of the ice layer, taken as 0.4-0.6; and g is gravitational acceleration, taken as 9.8 m/s².

7. The method for calculating the dynamic ice pressure on the earth-rockfill dam under the action of the wave and wind loads according to claim 2, wherein a formula for calculating the critical ice thickness h₂ₘₐₓ that causes flexural failure of the ice layer without the crack is as follows:
$${h}_{2 max} = \frac{{σ}_{c}^{2} ( 1 - {ν}^{2} )}{9 ερ gE}$$
in the formula, ε is a coefficient related to salinity and porosity of the ice layer, taken as 0.4-0.6; and g is gravitational acceleration, taken as 9.8 m/s².

8. The method for calculating the dynamic ice pressure on the earth-rockfill dam under the action of the wave and wind loads according to claim 1, wherein the dam slope shape coefficient is indicated with m, which is taken as 1 for a rectangular, and 0.9 for a polygon or a circle.

9. The method for calculating the dynamic ice pressure on the earth-rockfill dam under the action of the wave and wind loads according to claim 1, wherein the dam slope gradient coefficient indicated with λ, which is taken as 1 for a dam slope inclination of 0°-15°, and 0.8 for a dam slope inclination angle of 15°-45°.

10. The method for calculating the dynamic ice pressure on the earth-rockfill dam under the action of the wave and wind loads according to claim 1, wherein the viscosity coefficient of the ice layer is indicated with δ, which is taken as 1 for a temperature under −10° C., 0.95 for a temperature of −10° C.-0° C., and 0.9 for a temperature above 0° C.
